(19) United States
(12) Patent Application Publication
(10) Pub. No.: US 2019/0143947 A1
(43) Pub. Date: May 16, 2019

(54) QUICK DOLLY HEIGHT ADJUSTMENT DEVICE

(71) Applicant: Grosvenor Hanlin, JR., Norton, OH (US)

(72) Inventor: Grosvenor Hanlin, JR., Norton, OH (US)

(21) Appl. No.: 16/170,367

(22) Filed: Oct. 25, 2018

Related U.S. Application Data
(60) Provisional application No. 62/585,725, filed on Nov. 14, 2017.

(51) Int. Cl. B60S 9/04

(52) U.S. Cl. CPC B60S 9/04

(57) ABSTRACT

A dolly height adjustment device includes a cylindrical body member having a front face and a rear face. The device further includes a connection feature positioned on the front face, wherein the connection feature is configured to couple with a socket adapter attached to a drill. There is an opening on the rear face, a channel on the cylindrical body member, and a drive member of the dolly configured to be positioned in the opening, wherein the drive member includes a slot. Further, there is a bolt configured to pass through the channel and the slot of the drive member securing the device to the drive member. Advantageously, the drill is configured to raise and lower a height of the dolly via rotation.

### CROSS-REFERENCE TO RELATED APPLICATIONS

The present application claims benefit to U.S. Provisional Patent Application Ser. No. 62/585,725 titled “DOLLIE BUDDY”, which is hereby incorporated in its entirety at least by reference.

### BACKGROUND OF THE INVENTION

### 1. Field of the Invention

The present invention relates to the field of raising and lowering a trailer's landing gear, or dolly quickly.

### 2. Description of Related Art

Fogo; Neil R., Moore; Brian, U.S. Pat. No. 6,142,501 A, sets forth a recreational vehicle jack remote control is for use with a recreational vehicle having a pair of support jacks which are raised and lowered by means of an electric motor connected to the jacks. The electric motor is controlled by a normally open, double-pole, triple throw switch in the recreational vehicle. The recreational vehicle jack remote control is a modification of the circuit which includes a portable radio frequency transmitter, at least one radio frequency receiver mounted in the recreational vehicle, and a plurality of relays. The transmitter has an “up” button for raising the support legs, and a “down” button for lowering the support legs. When the “up” button is pressed, the relay coil of at least one relay is energized, closing the relay switch contacts to apply current to the electric motor with the proper polarity for raising the legs. When the “down” button is pressed, the relay coil of at least one relay is energized, closing the relay switch contacts to apply current to the electric motor with the opposite polarity for lowering the legs.

Central Hydraulics Co., U.S. Pat. No. 4,318,550 A, sets forth a system wherein a liquid, such as hydraulic oil, may be motivated by a pressurized gas, such as air. The system for operating landing gear of truck trailers in tractor-trailer combinations, which system is operative in response to motivating air pressure obtained from the air brake system of the tractor. The tractor-trailer landing gear actuating system of the type stated wherein novel means are presented for increasing the pressure applied to hydraulic fluid at any desired multiple of the line pressure of the air in the tractor brake system so that requisite forces provided for independently and reliably supporting the trailer together with its load.

Chappelle Warner A, U.S. Pat. No. 4,097,840 A, sets forth an automatic semi-trailer landing gear extension and retraction apparatus suitable for use with a conventional tractor having an operator's cab, a source of electrical power, and a fifth wheel hitch member. The apparatus is also employed in conjunction with a semi-trailer having hitch pin means on the forward end portion for engaging the fifth wheel hitch member of the conventional tractor, road wheels journaled on the rear end portion and an alternately extendable and retractable landing gear mounted intermediate the hitch pin means and the road wheels. Such landing gear is equipped with gear drive means operatively engaged therewith which includes an input drive shaft adapted to be engaged by a crank handle for manual rotation thereof in a first direction to extend the landing gear to engage the ground and support the semi-trailer independently of the tractor and, alternately, in a second direction to retract the landing gear from the ground engaging position to allow the forward end portion of the semi-trailer to be supported by the tractor with the hitch pin means engaging the fifth wheel hitch member.

It is apparent now that numerous innovations in devices for raising and lowering the dolly have been provided in the prior art that is adequate for various purposes. Furthermore, even though these innovations may be suitable for the specific individual purposes to which they address, accordingly, they would not be suitable for the purposes of the present invention as heretofore described.

### BRIEF SUMMARY OF THE INVENTION

The present invention has been developed in response to the present state of the art, and in particular, in response to the problems and needs in the art that have not yet been fully solved by the currently available devices for raising and lowering the dolly. Accordingly, the present invention has been developed to provide an apparatus for raising and lowering the dolly without the use of a hand crank.

It is therefore a primary object of the present invention to provide a device for raising and lowering the dolly, which includes a connection to a drill, breaker bar, socket wrench, impact driver, etc.

It is another object of the present invention to provide a device for raising and lowering the dolly, which may be used on any equipment with dolly cranks including horse trailers.

It is a further object of the present invention to provide the device for raising and lowering a dolly, which eliminates the need for cranking dollies up and down manually.

An even further object of the present invention is to provide a device for raising and lowering the dolly is constructed of a material selected from the group consisting of heat treated steel, iron and blends thereof.

Still yet another object of the present invention is to provide a device for raising and lowering the dolly, which may be easily and efficiently manufactured and marketed.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1A shows a front view of a quick dolly height adjustment device according to an embodiment of the present invention.

FIG. 1B shows a side view of the quick dolly height adjustment device according to an embodiment of the present invention.

FIG. 1C shows a rear view of the quick dolly height adjustment device according to an embodiment of the present invention.

FIG. 1D is a section view taken along section D-D of FIG. 1B

FIG. 2 is a perspective viewing showing a drill and socket adapter configured to be used with the quick dolly height adjustment device according to an embodiment of the present invention.

FIG. 3 is a perspective viewing showing the landing gear for a trailer for use the quick dolly height adjustment device according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a quick dolly height adjustment device.

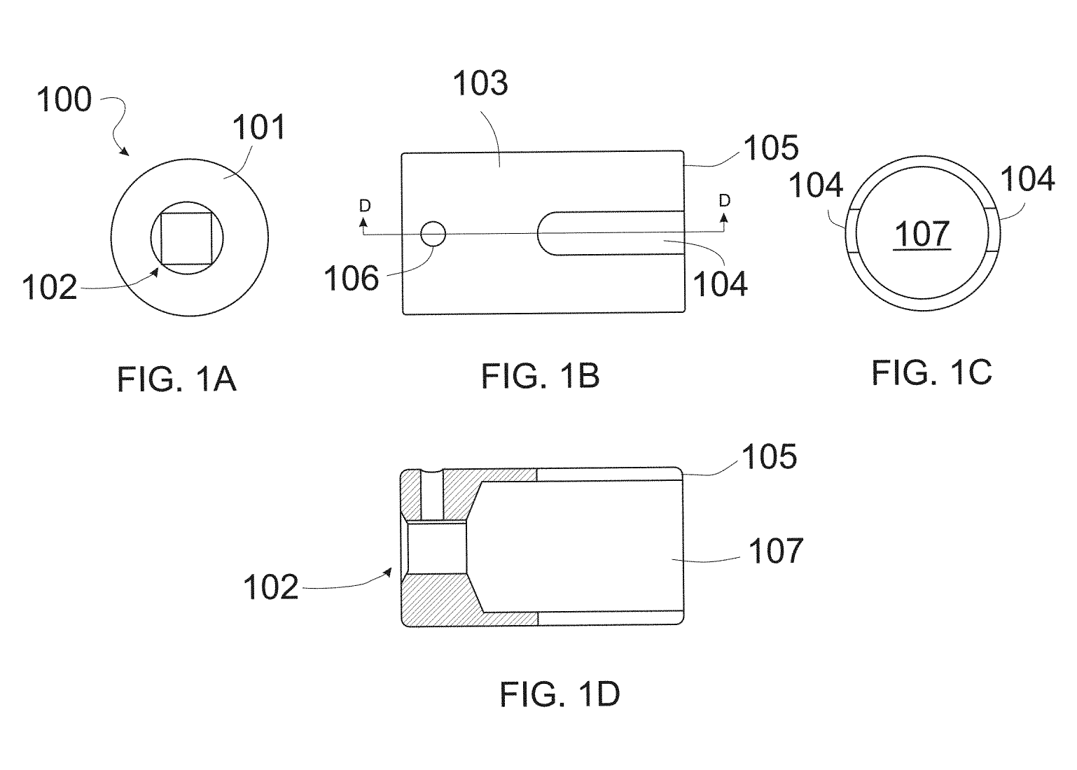

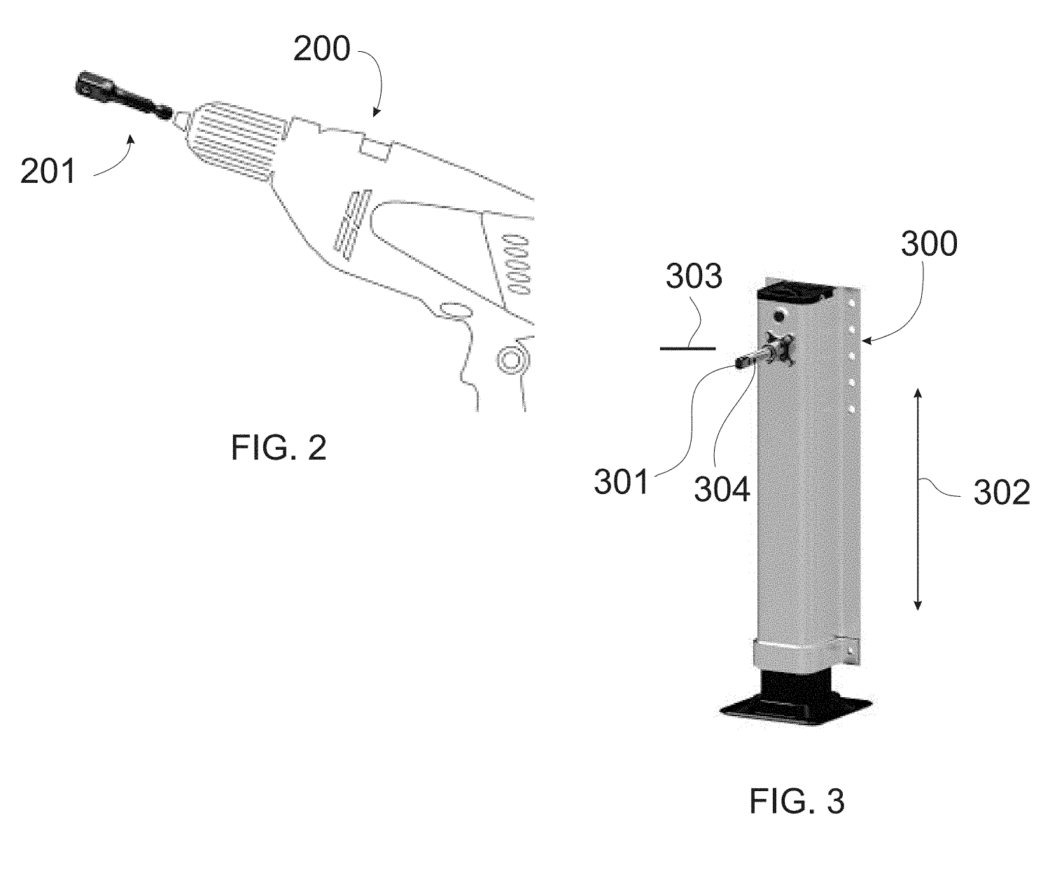

FIGS. 1A-D illustrate various views of a quick dolly height adjustment device 100 according to an embodiment of the present invention. Referring now, to FIGS. 1A-D, the quick dolly height adjustment device is illustrated. The device comprises a front face 101 having a connection 102 configured to attach to a socket adapter (201; FIG. 2) during use. This will be discussed in greater detail below.

Still referring to FIGS. 1A-D, the device is comprises a cylindrical body having a channel 104. In one embodiment, the channel opening size ⅜″, however the size may vary. A hole 106 positioned on the side of the cylindrical body connects to the connection, and is configured to receive a locking member of the socket adapter, securing the socket adapter to the device. The locking member is a small spring-located ball bearing as well known in the art. In one embodiment, a rear face 105 of the device has an opening 107 configured to accept a drive 301 (FIG. 3) of the dolly. In one embodiment, the device is constructed of a material selected from the group consisting of heat treated steel, iron and blends thereof.

Referring now to FIGS. 2 and 3, the use and operation of the device will be described. Shown in FIG. 3, is a landing gear leg (dolly) 300 used in most trailer applications. A drive 301 is attached to the dolly. Typically, a hand crank (not shown) is attached to the drive via a bolt 303 positioned through slot 304 on the drive. When the hand crank is rotated, the dolly is raised or lowered 302 based on the direction of rotation. It is a particular advantage of the present invention to utilize the quick dolly height adjustment device to raise and lower the dolly. Specially, the drive of the dolly is positioned in the opening of the device, and then the bolt is positioned horizontally through the channel and the drive via the slot. Typically, the bolt is ⅜″ in diameter, corresponding to the channel opening size. It is understood that the bolt size may vary and thus the channel size may vary to match the bolt size. Then, socket adapter 201 connected to a drill 200 (power or cordless) is engaged with connection 102 on the device. Advantageously, as the drill is rotated the dolly is raised or lowed easily depending on the directly of the rotation, clockwise or counterclockwise.

The device provides several advantages. First, there is no need to manually rotate a hand crank, reducing the risk of injury to a user's back, neck, and arm. Second, since the dolly can be raised and lowered much faster than traditionally means, users need to spend much less time in the elements, such as the rain, snow, wind, cold, and heat. Third, most truck drivers leave their truck running during pickup and drops, i.e. when they are raising and lowering the dolly. Thus the time saved using the present invention, will save fuel.

Although the invention has been described in considerable detail in language specific to structural features, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular,claims) are not used to show a serial or numerical limitation but instead are used to distinguish or identify the various members of the group.

What is claimed is:

1. A dolly height adjustment device comprising:
a cylindrical body member having a front face and a rear face;
a connection feature positioned on the front face, wherein the connection feature is configured to couple with a socket adapter attached to a drill;
an opening on the rear face;
a channel on the cylindrical body member;
a drive member of the dolly configured to be positioned in the opening, wherein the drive member includes a slot;
a bolt configured to pass through the channel and the slot of the drive member securing the device to the drive member;
the drill is configured to raise and lower a height of the dolly via rotation.

2. The dolly height adjustment device of claim 1, further comprising a hole positioned on the side of the cylindrical body connecting to the connection feature, wherein the hole is configured to receive a locking member of the socket adapter, securing the socket adapter to the device.

3. The dolly height adjustment device of claim 1, wherein said device is constructed of a material selected from the group consisting of heat treated steel, iron, and blends thereof.
